(19) United States
(12) Patent Application Publication
(10) Pub. No.: US 2021/0089469 A1
(43) Pub. Date: Mar. 25, 2021

(54) DATA CONSISTENCY TECHNIQUES FOR PROCESSOR CORE, PROCESSOR, APPARATUS AND METHOD

(71) Applicant: Alibaba Group Holding Limited, Georgetown (KY)

(72) Inventors: Taotao ZHU, Hangzhou (CN); Yimin LU, Hangzhou (CN); Xiaoyan XIANG, Shanghai (CN); Chen CHEN, Shanghai (CN)

(21) Appl. No.: 16/938,607

(22) Filed: Jul. 24, 2020

(30) Foreign Application Priority Data
Sep. 20, 2019 (CN) 201910890617.8

(51) Int. Cl. G06F 12/1045; G06F 16/23; G06F 13/40; G06F 9/30

(52) U.S. Cl. CPC G06F 12/1045; G06F 16/2365; G06F 2212/1032; G06F 9/3004; G06F 2212/68; G06F 13/4027

(57) ABSTRACT

A processor core, a processor, an apparatus, and a method are disclosed. The processor core is coupled to a translation lookaside buffer and a first memory. The processor core further includes a memory processing module that includes: an instruction processing unit, adapted to identify a virtual memory operation instruction and send the virtual memory operation instruction to a bus request transceiver module; the bus request transceiver module, adapted to send the virtual memory operation instruction to an external interconnection unit; a forwarding request transceiver unit, adapted to receive the virtual memory operation instruction broadcast by the interconnection unit and send the virtual memory operation instruction to the virtual memory operation unit; and the virtual memory operation unit, adapted to perform a virtual memory operation according to the virtual memory operation instruction. An initiation core sends the virtual memory operation instruction to the interconnection unit. The interconnection unit determines, based on an operation address, to broadcast the virtual memory operation instruction to at least one of a plurality of processor cores, so that all the cores can process the virtual memory operation instruction using the same hardware logic, thereby reducing hardware logic of the processor core.

### CROSS-REFERENCE TO RELATED APPLICATIONS

This application claims priority to Chinese Patent Application No. 201910890617.8 filed Sep. 20, 2019, which is incorporated herein in its entirety.

### TECHNICAL FIELD

The present invention relates to the field of chip manufacturing, and more specifically, to a processor core, a processor, an apparatus, and a method.

### BACKGROUND OF THE INVENTION

When executing a program, a multi-core processor needs to maintain consistency of data across cores, especially to maintain data consistency between address table entries associated with virtual memory operation instructions and cached data.

In related technologies, in the ARMACE bus solution (which is termed Distributed Virtual Memory Transactions, DVM transactions for short), it is necessary to first determine what type of address attribute an operation address of a virtual memory operation instruction has and take different execution actions accordingly. If the operation address has a sharing attribute, a current core sends a request to other cores in a same sharing area through an ACE bus, and the current core and the other cores perform a corresponding operation on an address entry associated with the operation address in a corresponding module in the respective cores. If the address has a non-sharing attribute, the current core does not send the request to the other cores through the ACE bus, but performs a corresponding operation on an address entry associated with the operation address in a corresponding module in the core itself. A disadvantage of this solution lies in that because each core needs to receive a request forwarded through the ACE bus, a single core needs to maintain both hardware logic A that initiates a request and that processes the request accordingly, and hardware logic B that receives a forwarded request and that processes the request accordingly. Therefore, in the hardware implementation process, two mechanisms are required to ensure completion of a function. A problem coming with this is increased or wasted hardware logic and increased mechanism complexity.

### SUMMARY OF THE INVENTION

In view of this, the present solution proposes a processor core, a processor, an apparatus, and a method to resolve the above problem.

To achieve this objective, according to a first aspect of the present invention, the present invention provides a processor core, where the processor core is coupled to a translation lookaside buffer and a first memory, and the processor core further includes a virtual memory processing module implemented in hardware logic, where the virtual memory processing module includes: an instruction processing unit, adapted to identify a virtual memory operation instruction from received instructions, and send the virtual memory operation instruction to a bus request transceiver module; the bus request transceiver module, adapted to send the virtual memory operation instruction to an external interconnection unit; a forwarding request transceiver unit, adapted to receive the virtual memory operation instruction broadcast by the interconnection unit and send the virtual memory operation instruction to a virtual memory operation unit; and the virtual memory operation unit, adapted to perform a virtual memory operation on data in the translation lookaside buffer and/or the first memory according to the virtual memory operation instruction received from the interconnection unit.

In some embodiments, the virtual memory operation unit is further adapted to send result information to the interconnection unit, and the bus request transceiver module is further adapted to receive returned information from the interconnection unit.

In some embodiments, the first memory includes at least one of a cache and a tightly coupled memory, and the first memory and the translation lookaside buffer are located inside the processor core.

In some embodiments, the first memory includes a cache, and the cache and the translation lookaside buffer are located outside the processor core.

In some embodiments, the instruction processing unit is further adapted to acquire a sharing attribute of an operation address in the virtual memory operation instruction, and send the sharing attribute to the interconnection unit through the bus request transceiver module.

In some embodiments, the virtual memory operation includes at least one of the following operations: deleting a corresponding page table entry in the translation lookaside buffer; and deleting data that a corresponding physical address of the first memory points to.

According to a second aspect of the present invention, a processor is provided, where the processor includes a plurality of processor core, where the processor core is the processor core according to any one of the above embodiments, and the processor further includes a multi-core consistency detection module coupled to the plurality of processor cores through the interconnection unit, where the multi-core consistency detection module is adapted to determine, based on the sharing attribute of the operation address in the virtual memory operation instruction, to broadcast the virtual memory operation instruction to at least one of the plurality of processor cores, and send returned information to the interconnection unit based on result information returned from the at least one of the plurality of processor cores.

In some embodiments, the multi-core consistency detection module is integrated with the interconnection unit.

According to a third aspect of the present invention, an apparatus is provided, where the apparatus includes the processor according to any one of the above embodiments and a second memory.

In some embodiments, the second memory is a dynamic random access memory.

In some embodiments, the apparatus is a system on chip.

According to a fourth aspect of the present invention, a method applied to a multi-core processor is provided, where the multi-core processor includes a plurality of processor cores coupled together through an interconnection unit, and each of the processor cores is coupled to a translation lookaside buffer and a first memory; each processor core acquires a physical address of a specified virtual address based on a mapping relationship between virtual addresses and physical addresses stored in the translation lookaside buffer and acquires data from the first memory based on the physical address of the specified virtual address, and the method includes the following operations: sending, by an initiation core of the plurality of processor cores, a virtual memory operation instruction to the interconnection unit; broadcasting, by the interconnection unit, the virtual memory operation instruction to at least one of the plurality of processor cores according to a sharing attribute of an operation address of the virtual memory operation instruction, where the at least one of the plurality of processor cores includes the initiation core; and receiving, by the at least one of the plurality of processor cores, the virtual memory operation instruction, and performing a virtual memory operation on data in the translation lookaside buffer and/or the first memory in the core itself.

In some embodiments, the method further includes: sending, by the at least one of the plurality of processor cores, result information of the virtual memory operation to the interconnection unit, and sending, by the interconnection unit, returned information to the initiation core based on the result information.

In some embodiments, the method further includes: acquiring, by the initiation core, the sharing attribute of the operation address in the virtual memory operation instruction, and sending the sharing attribute to the interconnection unit.

In some embodiments, the method further includes: acquiring, by the interconnection unit from the translation lookaside buffer, the sharing attribute of the operation address in the virtual memory operation instruction.

In some embodiments, the operations of the method are implemented in hardware logic.

According to a fifth aspect of the present invention, a mainboard on which a processor and other components are provided, where the processor is coupled to the other components through an interconnection unit provided by the mainboard, the processor includes a plurality of processor cores, where the processor core is the processor core according to any of the above embodiments, the mainboard further includes a multi-core consistency detection module coupled to the plurality of processor cores through the interconnection unit, and the multi-core consistency detection module is adapted to determine, based on a sharing attribute of an operation address in a virtual memory operation instruction, to broadcast the virtual memory operation instruction to at least one of the plurality of processor cores, and send returned information to the interconnection unit based on result information returned from the at least one of the plurality of processor cores, where the at least one of the plurality of processor cores includes the initiation core.

Compared with the prior art, the embodiments of the present invention have the following advantages: In a multi-core processor, an initiation core sends a virtual memory operation instruction to an interconnection unit; the interconnection unit determines and broadcasts the virtual memory operation instruction to at least one of a plurality of processor cores based on an operation address in the virtual memory operation instruction (if the broadcast is to only one processor core, then the virtual memory operation instruction is broadcast to only the initiation core), so that all the cores can process the virtual memory operation instruction using the same hardware logic, regardless of whether the virtual memory operation instruction operates at an operation address of a sharing attribute or an operation address of a non-sharing attribute. In this way, the hardware logic of the processor core is reduced, and mechanism complexity of the processor core is reduced.

### BRIEF DESCRIPTION OF THE DRAWINGS

The above and other objectives, features and advantages of the present invention will become more apparent from the description of the embodiments of the present invention with reference to the following accompany drawings. In the drawings,

FIG. 1 is a schematic structural diagram of a first apparatus used for implementing an embodiment of the present invention;

FIG. 2 is a schematic structural diagram of a second apparatus used for implementing an embodiment of the present invention;

FIG. 3A and FIG. 3B are schematic structural diagrams of a multi-core processor and a multi-core consistency detection unit constructed according to an embodiment of the present invention;

FIG. 4 is a flowchart of a method according to an embodiment of the present invention; and

FIG. 5 illustrates a two-level page table and how a processor performs translation from a virtual address to a physical address.

FIG. 6 illustrates a first-level page table.

### DETAILED DESCRIPTION OF THE INVENTION

The present invention is described below based on embodiments, but the present invention is not limited to these embodiments. In the following detailed description of the present invention, some specific details are described. Without such details, those skilled in the art can still fully understand the present invention. To avoid confusing the essence of the present invention, well-known methods, processes, and procedures are not described in detail. In addition, the accompany drawings are not necessarily drawn to scale.

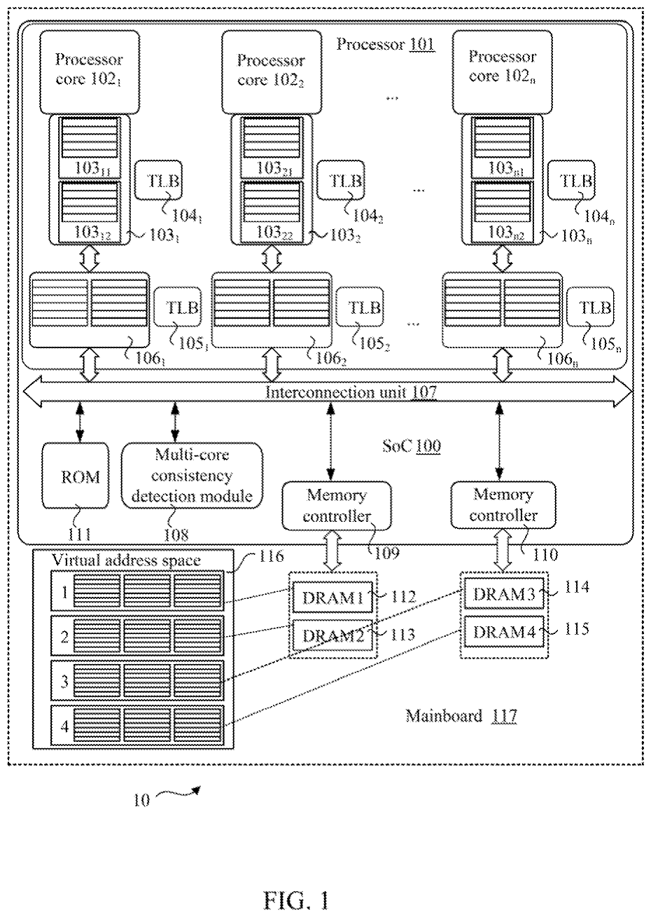

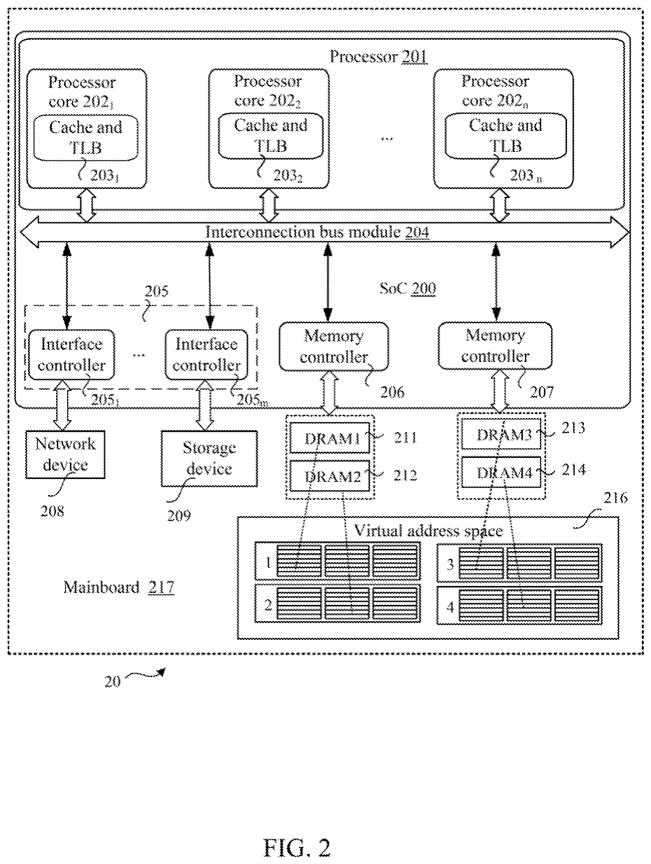

FIGS. 1 and 2 are schematic structural diagrams of a first apparatus and a second apparatus configured for implementing an embodiment of the present invention. As shown in FIG. 1, an apparatus 10 includes a system on chip (SoC) 100 mounted on a mainboard 117 and off-chip dynamic random access memories (DRAM) 112 to 115.

As shown in the figure, the system on chip 100 includes a multi-core processor 101, and the multi-core processor 101 includes processor cores 102₁ to 102ₙ, where n represents an integer greater than or equal to 2. The processor cores 102₁ to 102ₙ may be processor cores of a same instruction set architecture or different instruction set architectures, and are respectively coupled to first-level caches (cache) 103₁ to 103ₙ, and further to second-level caches 106₁ to 106ₙ. Further, the first-level caches 103₁ to 103ₐ may include instruction caches 103₁ to 103ₙ₁ and data caches 103₁₂ to 103ₙ₂, respectively, and be associated with translation lookaside buffers (that is, TLB, Translation Lookaside Buffer) 104₁ to 104ₙ, respectively. In some embodiments, the instruction cache and the data cache have their respective translation lookaside buffers, each processor core acquires a physical address of a specified virtual address based on a mapping relationship between virtual addresses and physical addresses stored in the translation lookaside buffer, and acquires instruction data from the first-level and second-level caches based on the physical address of the specified virtual address. The system on chip 100 further includes an interconnection circuit adapted to connect the processor 101 and various other components, and the interconnection circuit may support various interconnection protocols and interface circuits required for different needs. For simplicity, the interconnection circuit is shown herein as an interconnection unit 107. A read-only memory (ROM) 111, a multi-core consistency detection module 108, memory controllers 109 and 110 are coupled to the interconnection unit 107, implementing communication relationships between the multi-core processor 101 and the components, as well as communication relationships between the components. It should also be noted that the system on chip 100 may further include additional components and interface circuits that are not shown due to insufficient space, for example, various memories (for example, a tightly coupled memory and a flash memory) that can be disposed on the system on chip, and various interface circuits adapted to connect external devices. The memory controllers 109 and 110 may be connected to one or more memories. As shown in the figure, the memory controller 109 is connected to off-chip dynamic random access memories 112 and 113, and the memory controller 110 is connected to off-chip dynamic random access memories 114 and 115.

The dynamic random access memories have corresponding physical address spaces. Typically, a physical address space is divided into blocks (block) and then further divided into pages (page). Generally, a system reads and writes in pages. Although the processor may directly use a physical page as a unit to perform read and write operations, the present invention is a technical solution implemented based on a TLB. Therefore, in this embodiment, physical address spaces of the dynamic random access memories 112 to 115 are mapped to virtual pages 1 to 4 of a virtual address space 116. The virtual address space is also usually divided into a plurality of virtual pages. The read and write operations performed by the processor on the dynamic random access memory are implemented based on translation from the virtual address space to the physical address space. The mapping relationship can be processed by the memory controller and/or other components (including an IOMMU and the TLB), and an operating system (if any) can further provide complete software functionality. Similarly, a physical address space of a first-level cache and/or a second-level cache associated with each core can also be mapped to a virtual address space. In addition, mapping relationships between physical address spaces and virtual address spaces of the first-level and second-level caches and the dynamic random access memories can all be stored in a TLB associated with each processor core.

In some embodiments, if the memory controller (for example, 109 or 110 in the figure) has a DMA (direct memory access) capability, a translation lookaside buffer (not shown) may also be provided inside the memory controller, such that translation from a virtual address to a physical address can be implemented directly using a locally stored mapping relationship without the help of the processor, thereby implementing DMA.

In some embodiments, the mainboard 117 is, for example, a printed circuit board, and the system on chip 100 and the dynamic random access memory are coupled together through a slot provided on the mainboard. In other embodiments, the system on chip 100 and the dynamic random access memory are coupled to the mainboard through direct coupling technology (for example, flip-chip bonding). In both cases, a board-level system is formed. In the board-level system, the various components on the mainboard are coupled together through the interconnections provided by the mainboard. In addition, alternatively, a single system on chip may be configured for implementing this embodiment of the present invention. Taking the system on chip 100 shown in the figure for example, the dynamic random access memories 112 to 115 are all packaged in the system on chip 100, and the system on chip is configured for implementing the embodiments of the present invention.

In FIG. 2, an apparatus 20 includes a system on chip 200, four off-chip DRAM memories 211 to 213, a network device 208, and a storage device 209. The system on chip 200 includes a multi-core processor 201, an interface 205, and memory controllers 206 and 207 that are connected through an interconnection bus module 204. Each of processor cores 202₁ to 202ₙ of the multi-core processor 201 includes a cache and TLB 203₁ to a cache and TLB 203ₙ, which may be considered as composites of caches (or tightly coupled memories) and TLBs of the processor cores in FIG. 1. The interconnection bus module 204 may be considered as a composite of the interconnection unit 107 and the multi-core consistency detection module 108 in FIG. 1. To be specific, the function of the multi-core consistency detection and the function of connecting the components of the system on chip are integrated in the interconnection bus module 204. The interface 205 may be considered as a composite of hardware logic and software logic of various types of interface circuits, and may include interface controllers 205₁ to 20ₘ that are independent in hardware logic (as separate devices) or independent only in software logic, where m is a positive integer. The system on chip 200 may connect various types of external devices such as a network device 208, a storage device 209, a keyboard (not shown), and a display device (not shown) through the interface 205. The memory controller 206 and 207, and DRAMs 211 to 214 are the same as the corresponding components in FIG. 1, and are not further described herein.

The following further describes in detail how to achieve, based on the apparatuses shown in FIGS. 1 and 2, data consistency of cached data and address table entries associated with virtual memory operation instructions. Carriers for implementing this function are the processor cores and the multi-core consistency detection module shown in FIG. 1, or the processor cores and the interconnection bus module shown in FIG. 2. In addition, this function may be provided by, for example, an FPGA programmable circuit/logic or an ASIC (Application Specific Integrated Circuit) chip.

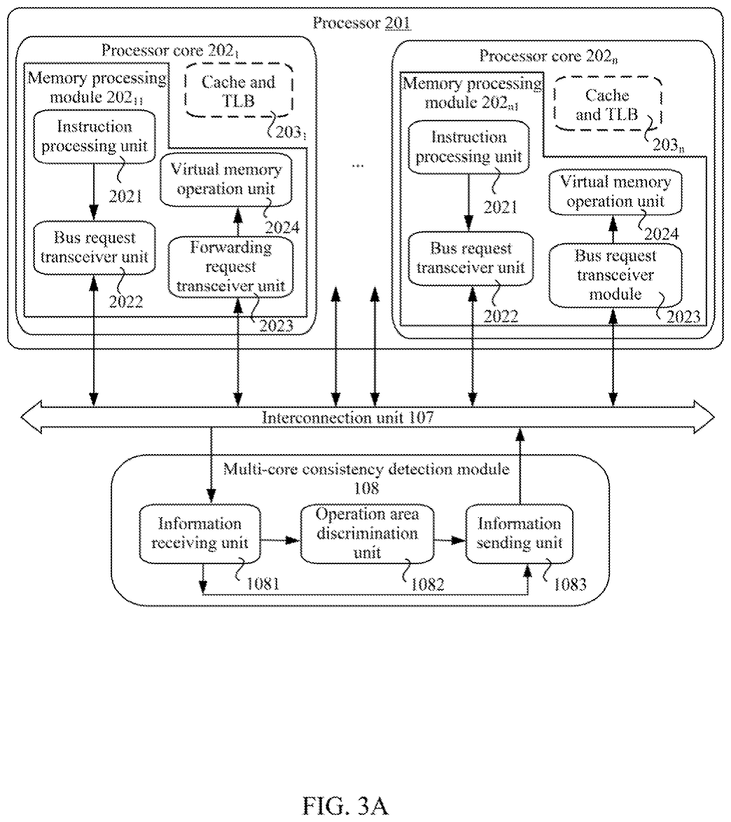

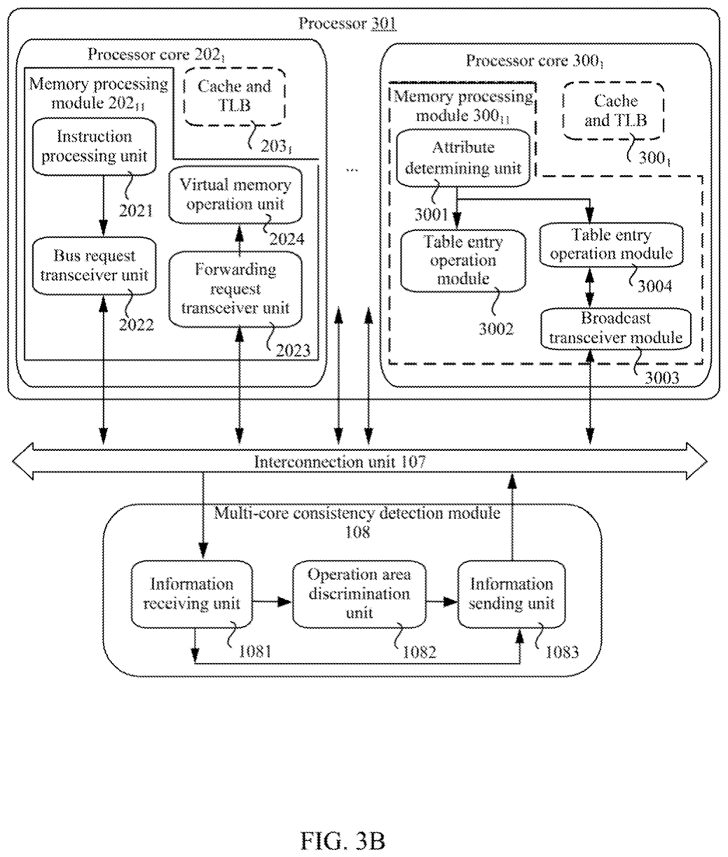

FIG. 3A is a schematic structural diagram of a multi-core processor and a multi-core consistency detection unit constructed according to an embodiment of the present invention.

In addition to a same identifier, processor cores 202₁ to 202ₙ in FIG. 3A include memory processing modules 202₁ to 202ₙ₁ implemented in hardware logic, respectively. Each of the memory processing modules 202₁₁ to 202ₙ₁ includes an instruction processing unit 2021, a bus request transceiver module 2022, a forwarding request transceiver module 2023, and a virtual memory operation unit 2024. Each of the processor cores 202₁ to 202ₙ further includes a general pipeline structure (not shown), and the general pipeline structure is used to fetch, decode, execute executable code of a program according to an instruction set encapsulated in the processor core. Virtual memory operation instructions may be derived from the instruction pipeline structure. The instruction pipeline structure may, after executing a piece of executable code, send the executable code to the instruction processing unit 2021 for discrimination, or send the virtual memory operation instruction to the instruction processing unit 2021 according to an execution status at an execution phase. Certainly, the virtual memory operation instructions may alternatively be derived from other components in the processing core that are not shown in the figure.

The instruction processing unit 2021 is adapted to discriminate an instruction, and if the instruction is a virtual memory operation instruction, notify the bus request transceiver module 2022.

The bus request transceiver unit 2022 is adapted to receive the virtual memory operation instruction from the instruction processing unit 2021 and send the virtual memory operation instruction to an interconnection unit 107. In addition, the bus request transceiver unit 2022 is adapted to receive returned information from the interconnection unit 107. The returned information is result information of an execution status of each processor core for a virtual memory operation.

The forwarding request transceiver unit 2023 is adapted to receive the virtual memory operation instruction broadcast by the interconnection unit 107, and notify the virtual memory operation unit 2024. When the virtual memory operation unit 2024 notifies that the operation of the virtual memory operation unit 2024 is completed, the forwarding request transceiver unit 2023 sends, to the interconnection unit 107, result information indicating that the virtual memory operation is completed.

The virtual memory operation unit 2024 is adapted to accept control of the forwarding request transceiver unit 2023, and when receiving the virtual memory operation instruction, control an internal module to execute the virtual memory operation. In the present invention, the virtual memory operation instruction corresponds to the virtual memory operation. Virtual memory operation instructions are used to represent a type of instruction in relation to address entries of virtual addresses and physical addresses, whereas an operation address included in a virtual memory operation instruction may be a physical address or a virtual address. Therefore, a virtual memory operation corresponding to the virtual memory operation instruction may include at least one of the following operations: deleting a page table entry representing a mapping relationship between the virtual address and the physical address, and deleting data that the physical address points to. For example, if a page table entry representing a mapping relationship between a virtual address and a physical address is stored in a TLB, and corresponding data is stored in a DRAM, only the corresponding page table entry, or only the corresponding data in the DRAM, or both of them may be deleted according to an operation type of the virtual memory operation instruction.

The interconnection unit 107 is adapted to receive the virtual memory operation instruction from the bus request transceiver unit 2022, forward the virtual memory operation instruction to a multi-core consistency detection module 108, receive returned information sent by the multi-core conformance detection module 108, and forward the returned information to the bus request transceiver unit 2022.

The multi-core consistency detection module 108 interprets the transmission, determines, based on information of the interpretation, whether to send the virtual memory operation instruction to only a request-initiating processor core or broadcast the virtual memory operation instruction to both the request-initiating processor core and all other processor cores in a same sharing area, takes an execution action accordingly, waits for all the processor cores that have forwarded a request to send back result information indicating that the operation has been completed, and sends returned information to the interconnection unit 108 accordingly, to indicate that the virtual memory operation of each processor core has been completed. Upon receiving the returned information, the interconnection unit 108 sends the returned information to the request-initiating processor core.

In some embodiments, the multi-core consistency detection module 108 includes an information receiving unit 1081, an operation area discrimination unit 1082, and an information sending unit 1083. The information receiving unit 1081 is adapted to receive the virtual memory operation instruction from the interconnection unit 107 and the result information sent by each processor core and indicating that the virtual memory operation has been completed. The operation area discrimination unit 1082 is adapted to discriminate the operation address. If the operation address has a sharing attribute, the operation area discrimination unit 1082 broadcasts the sharing attribute to both the request-initiating processor core and all the other processor cores in the same sharing area. If the operation address has a non-sharing attribute, the operation area discrimination unit 1082 forwards the virtual memory operation instruction to only the request-initiating processor core. As an optional example, the sharing attribute of the operation address may be derived from the virtual memory operation instruction, that is, the sharing attribute is acquired from a TLB by the module 2021 or 2022 and is added into the virtual memory operation instruction and sent to the interconnection unit 107. As another optional example, the sharing attribute is acquired by searching a TLB by the multi-core consistency detection module 108. The information sending unit 1083 is adapted to broadcast, according to the sharing attribute, the virtual memory operation instruction to all processor cores in the sharing area or to the request-initiating processor core, and send the returned information to the request-initiating processor core.

FIG. 3B is a schematic structural diagram of a multi-core processor and a multi-core consistency detection unit constructed according to an embodiment of the present invention. Referring to FIG. 3B, a processor 301 is different from the processor core 201 shown in FIG. 3A in that, in addition to the at least one processor core 202₁ shown in FIG. 3A, the processor 301 further includes at least one processor core 300 implemented according to the prior art. The processor core 3001 may include a memory processing module 300₁₁ that is logically divided into an attribute determining unit 3001, a table entry operation module 3002, a broadcast transceiver module 3003, and a table entry operation module 3004. In this embodiment, for ease of illustration, the table entry operation module 3002 and the table entry operation module 3004 are shown in the figure. However, the two modules may be understood from a functional perspective as one module.

When the processor core 3001 serves as an initiation core, the attribute determining unit 3001 receives a virtual memory operation instruction and retrieves a sharing attribute of an operation address of the virtual memory operation instruction. If the operation address does not have a sharing attribute, a virtual memory operation in the processor core 3001 is executed by the operation module 3002. If the operation address has a sharing attribute, a virtual memory operation in the processor core 3001 is executed by the table entry operation module 3004, and the virtual memory operation instruction is sent by the broadcast transceiver module 3003 to the interconnection unit 107, and is broadcast by the interconnection unit 107 to other processor cores.

When the processor core 3001 serves as a receiving core, the broadcast transceiver module 3003 receives a virtual memory operation instruction from the interconnection unit 107, and sends the virtual memory operation instruction to the table entry operation module 3004 for a virtual memory operation.

Compared with the processor core 202₁, the processor core 3001 requires two mechanisms in order to act as an initiation core and a receiving core. In some scenarios, however, a processor with a combination of two mechanisms can be used to achieve specific purposes.

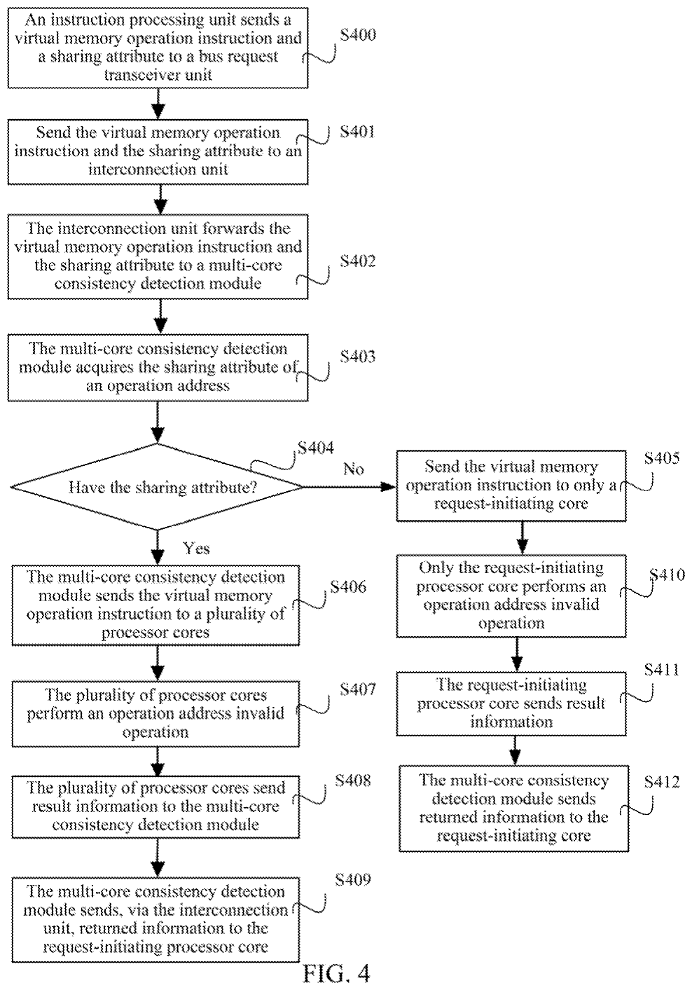

FIG. 4 is a flowchart of a method according to an embodiment of the present invention. As shown in the figure, the process is described as follows.

In step S400, an instruction processing unit receives an instruction and interprets it; when discovering that the instruction is a virtual memory operation request, sends a virtual memory operation instruction and a sharing attribute of an acquired operation address together to a bus request transceiver unit.

In step S401, the bus request transceiver unit sends the virtual memory operation instruction and the sharing attribute of the operation address together to an interconnection unit.

In step S402, the interconnection unit forwards the virtual memory operation instruction and the sharing attribute of the operation address together to a multi-core consistency detection module.

In step S403, the multi-core consistency detection module acquires the sharing attribute of the operation address.

In step S404, the multi-core consistency detection module determines whether the operation address has the sharing attribute. If yes, step S406 is performed; otherwise, step S405 is performed.

In step S405, the multi-core consistency detection module sends the virtual memory operation instruction to only a request-initiating processor core.

In step S406, the multi-core consistency detection module sends the virtual memory operation instruction to both the request-initiating processor core and all other processor cores in a same sharing area.

In step S407, a plurality of processor cores perform virtual memory operations, for example, deleting a mapping relationship between a virtual address and a physical address in a TLB, or deleting only cached data specified by the operation address in a cache.

In step S408, the plurality of processor cores send, to the multi-core consistency detection module, result information indicating that a virtual memory operation is completed.

In step S409, the multi-core consistency detection module sends, through the interconnection unit, returned information to the request-initiating processor core.

In step S410, only the request-initiating processor core performs a virtual memory operation.

In step S411, the request-initiating processor core sends result information indicating that the virtual memory operation is completed.

In step S412, the multi-core consistency detection module sends returned information to the request-initiating processor core.

It should be noted that, in the example of FIG. 4, it is assumed that the instruction processing unit acquires the sharing attribute of the operation address, but in practice, the sharing attribute may be acquired from the TLB by the multi-core consistency detection module as well. In addition, although the separate interconnection unit and the multi-core consistency detection module are separate from each other in FIG. 4 to illustrate the process of this embodiment, as shown in FIG. 2, the interconnection unit and the multi-core consistency detection module may be integrated, and when the two are integrated, some steps of data forwarding in the figure may be omitted.

According to this embodiment of the present invention, in the multi-core processor, an initiation core sends a virtual memory operation instruction to an external interconnection unit; the interconnection unit determines to broadcast and broadcasts the virtual memory operation instruction to at least one of a plurality of processor cores, based on an operation address in the virtual memory operation instruction (if the broadcast is to only one processor core, the virtual memory operation instruction is broadcast to only the initiation core), so that all the cores can process the virtual memory operation instruction using the same hardware logic, regardless of whether the virtual memory operation instruction operates at an operation address of a sharing attribute or an operation address of a non-sharing attribute. In this way, the hardware logic of the processor core is reduced, and mechanism complexity of the processor core is reduced. Further, because discrimination and broadcasting are performed through a bus, overall efficiency of the system is less affected.

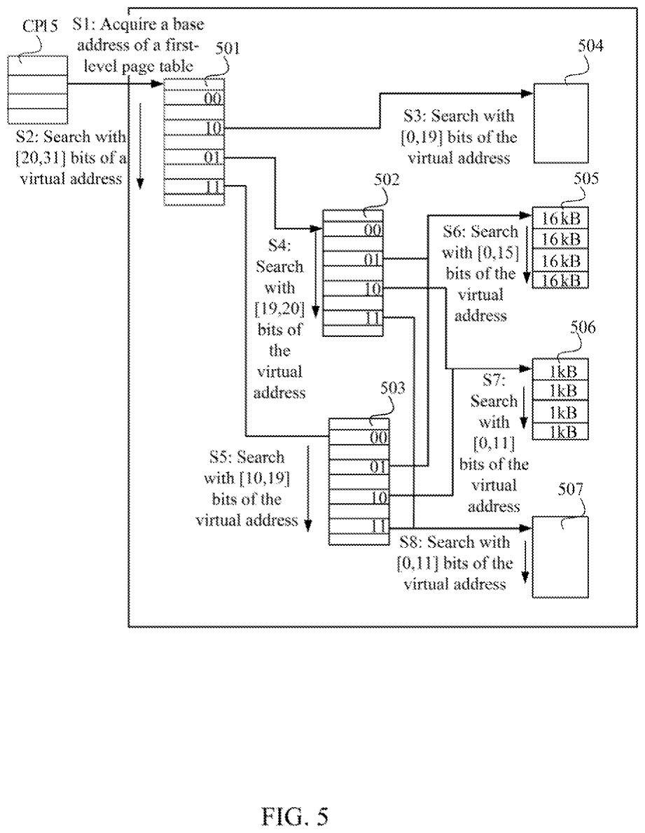

FIG. 5 illustrates a two-level page table and how a processor performs translation from a virtual address to a physical address.

Referring to FIG. 5, 501 represents a first-level page table, and 502 and 503 represent second-level page tables. Each page table includes a plurality of page table entries, and each page table entry stores a mapping relationship between one virtual address and one address. The address may be a base address of a lower-level page table (in a case that there is still another level of page table under the current page table) or a physical address corresponding to the virtual address (in a case that the current page table is a page table of the lowest level). 504 to 507 represent page table data of different size specifications, including section data (with a read/write granularity of 1 MB), coarse page data (with a read/write granularity of 64 KB), fine page data (with a read/write granularity of 4 KB) and super fine page data (with a mad/write granularity of 1 KB).

Based on FIG. 5, the processor processes each virtual memory operation instruction in the following steps.

In step S1, the processor extracts a base address of a first-level page table from a TTB (translation table base register) of a coprocessor CP15.

In step S2, a first-level page table 501 is retrieved according to the base address acquired in step S1, and a data block including final data is acquired by searching from the base address of the first-level page table 501 with [20, 31] bits of a virtual address in the virtual memory operation instruction.

In step S3, if the lowest bits of the data item are ‘10’, page table data 504 is searched with [0, 19] bits of the virtual address as a physical address.

In step S4, if the lowest bits of the data item are ‘01’, a base address is acquired by parsing the data item according to a data specification of a page table entry of ‘01’ type, then a second-level page table 502 is found according to the base address, and a data item is acquired by searching from the base address of the second-level page table 502 with [19, 20] bits of the virtual address.

In step S5, if the lowest bits of the data item am ‘11’, a base address is acquired by parsing the data item according to a data specification of a page table entry of ‘11’ type, a second-level page table 503 is found according to the base address, and a data item is acquired by retrieving [19, 20] bits of a virtual address from the base address of the second-level page table 503.

In step S6, if the lowest bits of the data item acquired in step S4 or S5 are ‘01’, a base address is acquired by parsing the data item according to a data specification of a page table entry of ‘01’ type, then page table data 505 is found according to the base address, and a data block including final data is acquired by searching from the base address of the page table data 505 with [0, 15] bits of the virtual address.

In step S7, if the lowest bits of the data item acquired in step S4 or S5 are ‘10’, a base address is acquired by parsing the data item according to a data specification of a page table entry of ‘10’ type, then page table data 506 is found according to the base address, and a data block including final data is acquired by searching from the base address of the page table data 506 with [0, 11] bits of the virtual address.

In step S8, if the lowest bits of the data item acquired in step S4 or S5 are ‘11’, a base address is acquired by parsing the data item according to a data specification of a page table entry of ‘11’ type, then page table data 507 is found according to the base address, and a data block including final data is acquired by searching from the base address of the page table data 507 with [0, 11] bits of the virtual address.

For clear purposes, permission checking is not involved in the above flowchart. In practice, however, when the current page table entry stored in the page table is a last-level page table entry, the page table entry will typically also store permission data, and permission check is required according to the parsed permission data.

A single-core processor processes memory searching in essentially the same way as a multi-core processor. However, as the multi-core processor needs to keep consistency between cached data and mapping relationships between virtual addresses and physical addresses stored in the processor cores, the multi-core processor still needs to perform a virtual memory operation.

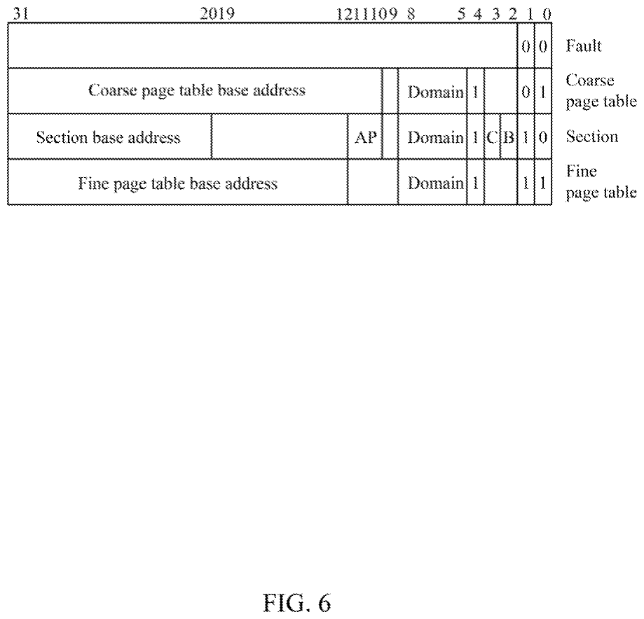

The following uses the data specifications of the first-level page table shown in FIG. 6 as an example to illustrate the process of implementing a virtual memory operation. Referring to FIG. 6, the lowest bits of the page table entry are ‘00’, which are a fault format indicating that a virtual address in the range is not mapped to a physical address. If the lowest bits of the page table entry are ‘10’, a section format is indicated for which there is no second-level page table and direct mapping to page table data is implemented, domain and AP bits control access permissions, and C and B bits control a cache. If the lowest two bits of a descriptor are ‘01’ or ‘11’, they correspond to two second-level page tables of different specifications. The virtual memory operation is essentially to cancel a mapping relationship between a virtual address and a physical address. In this example, only a section-formatted page table entry (the lowest bits are ‘10’) represents a mapping relationship between a virtual address and a physical address. Therefore, when the mapping relationship between the virtual address and the physical address is canceled, the lowest bits ‘10’ can be directly changed to ‘00’ (representing a fault format), or certainly, the page table entry may be directly deleted. In addition, the corresponding page table data can also be deleted. Certainly, the steps of deleting a page table entry and page table data may alternatively be performed separately based on an operation type of the virtual memory operation instruction. For example, if the virtual memory operation instruction only requires deleting a page table entry, only a page table entry in a TLB is deleted.

It can be understood that the illustrated data specifications are for illustrative purposes only, and are not intended to limit the present invention. The applicant may design various data specifications based on actual needs to represent the mapping relationship between the physical address and the virtual address. In addition, the sharing attribute of the operation address may be stored in the page table entry, for example, added into AP and domain in FIG. 6, or certainly, may be stored elsewhere. This is not limited in the present invention.

According to the present invention, the above processing unit, processing system, and electronic device may be implemented in hardware, a dedicated circuit, software, or logic, or any combination thereof. For example, some aspects may be implemented in hardware, and other aspects may be implemented in firmware or software executable by a controller, a microprocessor, or other computing devices. The present invention is not limited thereto though. Although the various aspects of the present invention may be illustrated and described as block diagrams or flowcharts, or using some other graphical representations, it is well understood that, as non-limiting examples, the blocks, apparatuses, systems, techniques or methods described herein may be implemented in hardware, software, firmware, a dedicated circuit, logic, general hardware, a controller, or other computing devices, or some combination thereof. If involved, the circuit design of the present invention may be implemented in various components such as an integrated circuit module.

The above are merely preferred embodiments of the present invention and are not intended to limit the present invention. For those skilled in the art, the present invention may have various modifications and variations. Any modification, equivalent replacement, or improvement made without departing from the spirit and principle of the present invention shall fall within the protection scope of the present invention.

What is claimed is:

1. A processor core, wherein the processor core is coupled to a translation lookaside buffer and a first memory, and the processor core further comprises a memory processing module implemented in hardware logic, wherein the memory processing module comprises:
an instruction processing unit, adapted to identify a virtual memory operation instruction from received instructions, and send the virtual memory operation instruction to a bus request transceiver module;
the bus request transceiver module, adapted to send the virtual memory operation instruction to an interconnection unit;
a forwarding request transceiver unit, adapted to receive the virtual memory operation instruction broadcast by the interconnection unit and send the virtual memory operation instruction to a virtual memory operation unit; and
the virtual memory operation unit, adapted to perform a virtual memory operation on data in the translation lookaside buffer or the first memory according to the virtual memory operation instruction received from the interconnection unit.

2. The processor core according to claim 1, wherein the virtual memory operation unit is further adapted to send result information to the interconnection unit, and the bus request transceiver module is further adapted to receive returned information from the interconnection unit.

3. The processor core according to claim 1, wherein the first memory comprises at least one of a cache and a tightly coupled memory, and the first memory and the translation lookaside buffer are located inside the processor core.

4. The processor core according to claim 1, wherein the first memory comprises a cache, and the cache and the translation lookaside buffer are located outside the processor core.

5. The processor core according to claim 1, wherein the instruction processing unit is further adapted to acquire a sharing attribute of an operation address in the virtual memory operation instruction, and send the sharing attribute to the interconnection unit through the bus request transceiver module.

6. The processor core according to claim 1, wherein the virtual memory operation comprises at least one of a following operations:
deleting a corresponding page table entry in the translation lookaside buffer; and
deleting data that a corresponding physical address of the first memory points to.

7. A processor, comprising a plurality of processor cores, wherein the processor core is the processor core according to claim 1, and the processor further comprises a multi-core consistency detection module coupled to the plurality of processor cores through the interconnection unit, wherein the multi-core consistency detection module is adapted to determine, based on the sharing attribute of the operation address in the virtual memory operation instruction, to broadcast the virtual memory operation instruction to at least one of the plurality of processor cores, and send returned information to the interconnection unit based on result information returned from the at least one of the plurality of processor cores, wherein the at least one of the plurality of processor cores comprises an initiation core.

8. The processor according to claim 7, wherein the multi-core consistency detection module is integrated with the interconnection unit.

9. An apparatus, comprising the processor according to claim 7 and a second memory.

10. The apparatus according to claim 9, wherein the second memory is a dynamic random access memory.

11. The apparatus according to claim 9, wherein the apparatus is a system on chip.

12. A mainboard, on which a processor and other components are provided, wherein the processor is coupled to the other components through an interconnection unit provided by the mainboard, the processor comprises a plurality of processor cores, wherein the processor core is the processor core according to claim 1, and the mainboard further comprises a multi-core consistency detection module coupled to the plurality of processor cores through the interconnection unit, wherein the multi-core consistency detection module is adapted to determine, based on a sharing attribute of an operation address in a virtual memory operation instruction, to broadcast the virtual memory operation instruction to at least one of the plurality of processor cores, and send returned information to the interconnection unit based on result information returned from the at least one of the plurality of processor cores, wherein the at least one of the plurality of processor cores comprises an initiation core.

13. A method, applied to a multi-core processor, wherein the multi-core processor comprises a plurality of processor cores coupled together through an interconnection unit, and each of the processor cores is coupled to a translation lookaside buffer and a first memory; and the method comprises a following operations:
sending, by an initiation core of the plurality of processor cores, a virtual memory operation instruction to the interconnection unit;
broadcasting, by the interconnection unit, the virtual memory operation instruction to at least one of the plurality of processor cores according to a sharing attribute of an operation address of the virtual memory operation instruction; and
receiving, by the at least one of the plurality of processor cores, the virtual memory operation instruction, and performing a virtual memory operation on data in the translation lookaside buffer or the first memory in the core itself, wherein the at least one of the plurality of processors cores comprises the initiation core.

14. The method according to claim 13, wherein the method further comprises: sending, by the at least one of the plurality of processor cores, result information of the virtual memory operation to the interconnection unit, and sending, by the interconnection unit, returned information to the initiation core based on the result information.

15. The method according to claim 13, further comprising: acquiring, by the initiation core, the sharing attribute of the operation address in the virtual memory operation instruction, and sending the sharing attribute to the interconnection unit.

16. The method according to claim 13, further comprising: acquiring, by the interconnection unit from the translation lookaside buffer, the sharing attribute of the operation address in the virtual memory operation instruction.

17. The method according to claim 13, wherein the operations of the method are implemented in hardware logic.
